(19) United States
(12) Patent Application Publication
(10) Pub. No.: US 2007/0292685 A1
(43) Pub. Date: Dec. 20, 2007

(54) Perfluoropolymers

(76) Inventors: Paul Douglas Brothers, Chadds Ford, PA (US); John L. Netta, Newark, DE (US); Charles Joseph Noelke, Wilmington, DE (US); Philip S. Smith, Hope Mills, PA (US); Etsuya Taki, Yokohama-Shi (JP); Patricia A. Tooley, Dickson, TN (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/809,864

(22) Filed: Jun. 1, 2007

Related U.S. Application Data
(60) Provisional application No. 60/813,957, filed on Jun. 15, 2006.

(51) Int. Cl. B05D 5/12; B29C 47/02; B32B 15/08; C08G 79/00

(52) U.S. Cl. 428/378; 525/326.2; 428/34.1; 428/36.9; 264/171.13; 264/171.14; 264/171.15; 427/117; 528/401

(57) ABSTRACT

Perfluoropolymer made without ionic species, initiator and without halocarbon solvent polymerization medium and dispersing agent is beneficially useful in liquid contact or food contact applications, for high-speed melt extrusion wire coating, and to produce insulated wire exhibiting low dissipation factor at high signal frequencies.

### 1. FIELD OF INVENTION

This invention relates to improvements in perfluoropolymers, especially to perfluoropolymers used in processing of liquids and in wire insulation.

### 2. BACKGROUND OF THE INVENTION

Perfluoropolymers are known for their chemical resistance and chemical inertness. Nevertheless certain applications, such as process silicon wafer carriers and process piping systems of PFA (tetrafluoroethylene/perfluoroalkoxy copolymer) used in the manufacture of integrated circuits, have required that the PFA be fluorinated to form stable end groups, to avoid the formation of hydrogen fluoride (HF) by decomposition of unstable end groups. The HF in amounts less than 1 ppm in the process liquid used in this manufacture would harm the silicon wafer. This problem is described in J. Goodman et al., “Fluoride Contamination from Fluoropolymers in Semiconductor Manufacture”, Solid State Technology, July, 1990, pp. 65-68. The fluorination treatment to solve this problem is disclosed in U.S. Pat. No. 4,743,658.

Fluorination is also disclosed, along with high purity of the polymer by virtue of low metal content, to provide improved extrudability of tetrafluoroethylene/hexafluoropropylene copolymer (FEP), in U.S. Pat. No. 5,976,686. Fluoropolymers are disclosed in US 2004/0242855 A1 not to contaminate protein solutions with metals when the fluoropolymer is the interior surface of the vessel in which a protein separation process is carried out, this being an improvement as compared to when stainless steel is used as the separation vessel. In this patent publication, the fluoropolymer is preferably fluorinated.

Fluorination is also disclosed in EP 0 423 995 B1 to have an effect on electrical properties as wire insulation, both PFA and FEP, namely to reduce the dissipation factor (signal loss), as measured on molded plaques of the perfluoropolymer.

In all of the foregoing teachings, fluorination of the perfluoropolymer has been used to provide beneficial effects, depending on the particular utility of the perfluoropolymer. European Patent 1 162 212 discloses a different approach, namely to obtain ultrapure fluoropolymer from the polymerization process, by polymerizing in a fluoropolymer-lined reactor, and using ultra-pure water and halocarbon solvent as the polymerization medium, along with nonionic polymerization initiator and a chain transfer agent. This approach unfortunately is very expensive to carry out.

There is a need for further improvement in perfluoropolymer purity that enhances perfluoropolymer utility in existing applications and enables them to be applied in additional applications.

### SUMMARY OF THE INVENTION

It has been discovered that melt-fabricable perfluoropolymer made by polymerization in a medium comprising carbon dioxide (CO₂) provides perfluoropolymer that has enhanced utility in existing applications and even exhibits surprising results in certain applications. This polymerization is disclosed in U.S. Pat. No. 6,051,682. This polymerization is distinguishable from prior polymerizations in an aqueous medium or in a halocarbon solvent polymerization medium, because neither polymerization medium is present in the polymerization process used in the present invention. The polymerization initiator used in the polymerization in the CO₂ medium is a nonionic organic compound, preferably one which forms stable end groups, i.e. end groups that are perfluorocarbon or perfluoro(ether), instead of an inorganic salt (ionic species) of the type that is typically used in the aqueous dispersion polymerization process. Dispersing agent that is present in the typical aqueous dispersion polymerization process to form melt-fabricable perfluoropolymer is not present in the polymerization process used in the present invention. Even when dispersing agent is used in the aqueous dispersion polymerization process, it is not present in the final perfluoropolymer, the dispersing agent having been removed in the working up of the perfluoropolymer, including heating at least to the melting point of the perfluoropolymer, such as is involved in melt fabrication of the perfluoropolymer. The description of the perfluoropolymer being free of dispersing agent means that dispersing agent has never been used to make the perfluoropolymer. Thus, the polymerization process described above provides a perfluoropolymer, as polymerized, that is free of ionic species and free of dispersing agent.

The melt-fabricable perfluoropolymer, as polymerized, is also free of halocarbon solvent polymerization medium, i.e. the polymerization is not carried out in a halocarbon solvent polymerization medium. Small amounts of halocarbon diluent may be introduced in the polymerization as diluent for the nonionic initiator, though it is more preferable that CO₂ be the initiator diluent, as is disclosed in U.S. Pat. No. 6,395,937. By halocarbon diluent is meant fluids, nonpolymerizable by free radical polymerization, such as fluorocarbons, chlorofluorocarbons, hydrofluorocarbons, and hydrofluorochlorocarbons. When such diluent is present, its amount is preferably less than 2 wt % based on the total weight of the CO₂ polymerization medium including the halocarbon diluent, more preferably less than 1 wt %, and most preferably, no halocarbon diluent at all. The small amount of halocarbon diluent that may be present in the CO₂ polymerization medium does not form a continuous phase within which polymerization can occur.

One embodiment of the present invention is the use of the melt-fabricable perfluoropolymer in applications requiring ultra-high purity, i.e. wherein the perfluoropolymer will not contaminate materials such as food, including beverage, products, collectively referred to as “food” hereinafter, and non-food liquids, brought into contact with it. The state of the food product may range from liquid to solid, including dispersions, emulsions, and suspensions, as well as carbonated beverages. The non-food liquid includes such materials as chemicals, pharmaceuticals, and ultra-pure water, sometimes referred to as WFI (water for injection), commonly used in pharmaceutical manufacture. According to this embodiment, an article is provided such as by coating (lining) or fabrication, wherein at least the contact surface of the article for non-food liquids or food products is perfluoropolymer that as-polymerized is free of ionic species, dispersing agent, and halocarbon solvent polymerization medium. Examples of such articles include containment articles such as tubing, piping, liner (tank or pipe), rigid container and container made of flexible film, pumps, valves, and seals, and non-containment articles such as processing fixtures, and agitators.

According to another embodiment of the present invention, the melt-fabricable perfluoropolymer made by the process described above exhibits surprising melt-extrudability, i.e. extrudability at high line speeds for a considerable period of time without defects. This is most noticeable in the melt-extrusion coating of wire. According to this embodiment, the present invention includes a process comprising melt-extrusion coating wire with melt-fabricable perfluoropolymer, said perfluoropolymer as-polymerized being free of dispersing agent, ionic species, and halocarbon polymerization medium, whereby said coating is free of lumps when said coating is carried out at a speed of at least 1000 ft/min (305 m/min) for at least 8 hours, preferably at least 10 hrs. This level of performance has been exceeded for highest level performing communications cable made of twisted pairs of perfluoropolymer insulated wires, i.e. category 6 cable. The electrical performance of category 5e cable and category 6 cable is specified by ANSI/TIA/EIA-568-B.2, Addendum 1 (ANSI=American National Standards Institute; TIA=Telecommunications Industrial association; EIA=Electronics Industrial Association). To meet the higher level of communications signal performance of the category 6 cable as compared to the category 5e cable, requires a greater uniformity of insulation thickness and concentricity of the wire within the perfluoropolymer insulation than the category 5e cable. Cable manufacturers set their own thickness and concentricity specifications to meet the performance requirements for the category 6 cable, which are more stringent than for the category 5e cable. The effect of this more stringent dimensional uniformity is that the line speed for the extrusion coating process must be slowed down from that used for making insulated wire for category 5e cable. Since the trend is away from using category 5e cable towards using category 6 cable, the high speed extrusion process of the present invention has been demonstrated for the category 6 cable (Example 2). The line speed of 1200 ft/min (366 m/min) in Example 2, from experience is equivalent to a line speed of 1800 ft/min (549 m/min) to make category 5e cable.

The foregoing process is also useful for insulated wire for high speed electrical signal transmission, e.g. signal transmission at a frequency of at least 10 GHz. Surprisingly, the dissipation factor of the insulation measured on the perfluoropolymer made by polymerization as described above, and thereby being free of ionic species, dispersing agent, and halocarbon solvent polymerization medium is very low, i.e. the insulated wire has very low signal loss at such high frequency of signal transmission. This is an improvement over the same perfluoropolymer made by the most commonly used polymerization technique, aqueous dispersion polymerization, wherein ionic species from the polymerization initiator is inevitably present in the perfluoropolymer. The perfluoropolymer made without using ionic species exhibits a lower dissipation factor at 10 GHz than the corresponding perfluoropolymer made by aqueous dispersion polymerization. This improvement carries over into cable made from the insulated wire made from perfluoropolymer, which is in turn made by polymerization as described above, e.g. into coaxial cable, wherein the perfluoropolymer is the insulation between the core wire and the concentric shield, and twisted pair cable wherein each wire is the insulated wire described above. Such cable is usually formed from multiple pairs of insulated wire. According to this embodiment of the present invention, insulated wire is provided, wherein the insulation on the wire is melt-fabricable perfluoropolymer that as-polymerized is free of ionic species, dispersing agent, and halocarbon solvent polymerization medium, said insulated wire when it is coaxial cable exhibits a dissipation factor as measured on the cable of no greater than 0.00050 at 10 GHz.

In each of the embodiments described above, the perfluoropolymer used in such embodiment, whether as the article used for non-food liquid or food contact, melt extrusion or as wire insulation, is made in a carbon dioxide medium and as-polymerized is free of ionic species, i.e. inorganic salt such as ammonium and potassium persulfate. The surprising melt-extrudability of the perfluoropolymer and the surprisingly low dissipation factor of wire insulation made from the perfluoropolymer is thus obtainable as polymerized, e.g. without fluorination treatment of the perfluoropolymer. Fluorination treatment can be used however, if unstable end groups are present in the perfluoropolymer. In such case, even further improvement (reduction) in dissipation factor is obtained.

### DETAILED DESCRIPTION OF THE INVENTION

The perfluoropolymers used in the composition of the present invention are those that are melt-fabricable, i.e. they are sufficiently flowable in the molten state that they can be fabricated by melt processing such as extrusion, to produce products having sufficient strength so as to be useful. The melt flow rate (MFR) of the perfluoropolymers used in the present invention is preferably at least about 5 g/10 min, more preferably at least about 10 g/10 min, still more preferably at least about 15 g/10 min, even more preferably at least about 20 g/10 min, and most preferably, at least 26 g/10 min, as measured according to ASTM D-1238 at the temperature which is standard for the resin (see for example ASTM D 2116-91a and ASTM D 3307-93). As indicated by the prefix “per”, the monovalent atoms bonded to the carbon atoms making up the polymer chain are all fluorine atoms. Other atoms may be present in the polymer end groups, i.e. the groups that terminate the polymer chain. Examples of perfluoropolymers that can be used in the present invention include the copolymers of tetrafluoroethylene (TFE) with one or more perfluorinated polymerizable comonomers, such as perfluoroolefin having 3 to 8 carbon atoms, such as hexafluoropropylene (HFP), and/or perfluoro(alkyl vinyl ether) (PAVE) in which the linear or branched alkyl group contains 1 to 5 carbon atoms. Preferred PAVE monomers are those in which the alkyl group contains 1, 2, 3 or 4 carbon atoms, respectively known as perfluoro(methyl vinyl ether) (PMVE), perfluoro(ethyl vinyl ether) (PEVE), perfluoro(propyl vinyl ether) (PPVE), and perfluoro(butyl vinyl ether) (PBVE). The copolymer can be made using several PAVE monomers, such as the TFE/perfluoro(methyl vinyl ether)/perfluoro(propyl vinyl ether) copolymer, sometimes called MFA by the manufacturer. The TFE/PAVE copolymers are most commonly referred to as PFA. They typically have at least about 1 wt % PAVE, including when the PAVE is PPVE or PEVE, and will typically contain about 1-15 wt % PAVE. When PAVE includes PMVE, the composition is about 0.5-13 wt % perfluoro(methyl vinyl ether) and about 0.5 to 3 wt % PPVE, the remainder to total 100 wt % being TFE. Another group of perfluoropolymers is the TFE/HFP copolymers, which are commonly referred to as FEP. In these copolymers, the HFP content is typically about 6-17 wt %, preferably 9-17 wt % (calculated from HFPI×3.2). Preferably, the TFE/HFP copolymer includes a small amount of additional comonomer to improve properties. The preferred TFE/HFP copolymer is TFE/HFP/PAVE such as PEVE or PPVE, wherein the HFP content is about 6-17 wt %, preferably 9-17 wt % and the PAVE content, preferably PEVE, is about 0.2 to 3 wt %, and the remainder being TFE to total 100 wt % of the copolymer.

It is preferred that the fluoropolymer be partially crystalline, that is, not an elastomer. By partially crystalline is meant that the polymers have some crystallinity and are characterized by a detectable melting point measured according to ASTM D 3418, and a melting endotherm of at least about 3 J/g.

Equipment and process conditions for carrying out the polymerization in a stirred reactor to form perfluoropolymers such as FEP and PFA in a CO₂ polymerization medium are disclosed in U.S. Pat. No. 6,051,682. It is preferred that CO₂ be the sole polymerization medium. Temperature and pressure conditions in the polymerization reactor are selected to maintain the CO₂ in the medium in the desired form, i.e., liquid or supercritical, to control the reaction rate, and to adjust product properties and yield. The CO₂ is in the supercritical state when the temperature within the reactor is high enough (greater than 31° C., the critical temperature) that pressurization of the CO₂ in the reactor does not cause it to form a liquid phase. Typically, the temperature is kept between about 10 and about 80° C. Pressures are typically between 6.2 MPa and 10.3 MPa. Residence times are highly dependent upon the specific process being run in the reactor but typically range from about 10 to about 120 minutes.

The preferred initiator is hexafluoropropylene oxide dimer peroxide (HFPO dimer peroxide) as disclosed in U.S. Pat. No. 6,051,682, which forms the stable end group —CF(CF₃)—OCF₂CF₂CF₃. More preferred is this initiator in carbon dioxide medium prepared as disclosed in U.S. Pat. No. 6,395,937, and most preferred is this initiator in carbon dioxide prepared without the use of metal ion containing reagents, as disclosed in Example 7 of the '937 patent. Other nonionic organic initiators can be used. It is preferred they be perfluorinated, i.e. have no monovalent atoms other than fluorine attached to carbon atoms. Preferred initiators in this class include the above-mentioned HFPO dimer peroxide and perfluoroacyl peroxides, such as perfluoropropionyl peroxide and perfluorobutyrl peroxide. Chain transfer agent such as an alkane may or may not be used in the polymerization to make the perfluoropolymer. Typically the polymerization reactor is flushed with CO₂, followed by pressurizing the interior of the reactor with CO₂, HFP, PPVE, and chain transfer agent at their concentrations when the polymerization is running at steady state. TFE is at 90% of the steady-state concentration. The reactor is heated to the polymerization temperature desired. The initiator and CO₂ polymerization medium is then added to the reactor, followed by feeding of the monomers, in CO₂, to be copolymerized, initiator, and chain transfer agent, if present, at the desired rate to the reactor.

When the initiator is a perfluorinated nonionic compound such as HFPO dimer peroxide, the perfluoropolymer end groups are stable end groups, terminating in —CF₃, the same end group that is produced by fluorination treatment of perfluoropolymer that has unstable end groups typically arising from aqueous dispersion polymerization such as —CONH₂, COOH, and/or —COF. The unstable end group —COF may be present in the polymerization in the CO₂ medium, which arises from the PAVE monomer if present in the polymerization reaction, if the polymerization temperature is high enough. Fluorination treatment is disclosed in EP 0 226 668 B1 and EP 0 222 945 B1 and U.S. Pat. No. 4,743,658. Such fluorination treatment can be practiced on the perfluoropolymers made in accordance with the present invention. When alkane or other chain transfer agent is used in the polymerization reaction, end groups of lesser stability than —CF₃ will be formed, e.g. —CF₂H and —CH₂CH₃ in the case of ethane as the chain transfer agent. These as well as any other unstable end group, i.e. less stable than —CF₃, will be converted to the most stable end group —CF₃ upon fluorination treatment. Should fluorination treatment be used in the present invention, the resultant perfluoropolymer will then have less than about 20 unstable end groups, preferably leas than about 10 unstable end groups (hydrogen containing, —COF, and —CF═CF₂) per 10⁶ carbon atoms. The reference to “unstable end groups” implies a chemical or thermal instability, not withstanding that the end group —CF₂H has sufficient chemical and thermal stability to enable the perfluoropolymer to be melt fabricated without decomposition to form bubbles in the polymer. In the context of electrical performance, most notably low dissipation factor, it has been found that the most stable end group —CF₃ on the perfluoropolymer gives the lowest dissipation factor. The presence of the —CF₃ end group is not measurable however. Its presence is deduced from (a) chemistry, i.e. the result of fluorine treatment or the chemistry of the agents present during polymerization, e.g. the initiator, and (b) end group analysis showing the absence of hydrogen-containing, —COF, —COOH, and —CF═CF₂ end groups.

The articles of melt-fabricable perfluoropolymer intended for contact with non-food liquid or food in food processing can be made by such fabrication processes as injection molding of processing fixtures such as hangers and baskets, melt extrusion to make tubing or film for piping or linings and flexible containers, respectively, and blow molding of rigid containers from extruded tubular parisons.

Linings can be obtained by adhering extruded film to the surface to be lined, using an adhesive such as polyurethanes and epoxy resins as disclosed in E. M. Petrie, Chapter 10, Plastics and Elastomers as Adhesives, Handbook of Plastics and Elastomers, C. A. Harper, ed. McGraw-Hill, NY (1975). Additional adhesives are disclosed in A. H. Landrock, Adhesives Technology handbook, Noyes Publications (1985), such as nitrile phenolics (p. 163), hotsetting phenolics (p. 165), polybenzimidazole (p. 166), polyimide (p. 168), and polysulfone (p. 170). Linings of pipe can be obtained by inserting tubing of the melt-fabricable perfluoropolymer into the pipe to be lined.

The liquids that might be used in contact with the articles of the present invention include aqueous and non-aqueous solutions and dispersions, such as the processing liquids used in semiconductor manufacture and the liquid media used in the manufacture of pharmaceuticals, particularly biopharmaceuticals, wherein small amount of impurity can weaken or denature the therapeutic ingredient, typically a protein. In contact with food during food processing, the food may be in liquid, semi-solid or solid form food products.

The insulation can be on wires to make twisted pairs or as the electrical insulation between core wire and shield of coaxial cable. The melt extrusion fabrication is preferably melt-draw-down extrusion, wherein the perfluoropolymer is extruded as a tube, having a larger inner diameter than the diameter of the wire being coated. The line speed of the wire is faster than the extrusion rate of the perfluoropolymer, which is then drawn down, to form a melt cone, into contact with the wire to assume the line speed of the wire. The draw-down is accomplished by drawing a vacuum within the interior of the extruded tube. The use of melt draw-down extrusion enables the line speed (speed of wind up of the insulated wire) to be much greater than the rate of extrusion of the perfluoropolymer from the die tip. The molten cone of perfluoropolymer that is formed by the draw-down onto the wire, however, is the source of dimensional instability that affects insulation thickness uniformity and uniformity of concentricity of the wire within the insulation coating. The greater the difference between line speed and extrusion rate, the greater is the tendency for non-uniformity in the insulation coating on the wire. For this reason, the category 6 cable, requiring improved signal communication performance as compared to category 5e cable, has to be made at a slower line speed than category 5e cable. For category 6 cable, however, the perfluoropolymer made according to the present invention and thereby being free of ionic species, dispersing agent, and halocarbon solvent polymerization medium, melt extrusion at a line speed of at least 1000 ft/min (305 m/min) is high speed.

New articles can be made by from the melt-fabricable perfluoropolymer used in the present invention, such as wire, including cable, satisfying stringent dissipation factor requirements at very high signal frequency.

### EXAMPLES

### Example 1

In this Example, various articles are produced from melt-fabricable perfluoropolymer made as follows. A 3-gallon reactor is used. The reactor is flushed with CO₂ to remove oxygen, and then charged with CO₂ 21.2%, HFP 68.4%, PPVE 1.1%, TFE 9.3%, and ethane 45 ppm. The reactor temperature is heated to about 60° C., reactor pressure is 1800 psig (12.5 MPa). The feed to the reactor is 11.7 kg/hr. The feed composition is 67.7 wt % hexafluoropropylene (HFP), 10.2 wt % tetrafluoroethylene (TFE), 1.1 wt % perfluoro(ethyl vinyl ether) (PEVE), 21.0 wt % carbon dioxide (CO₂). The feed also contains 45 ppm ethane as chain transfer agent. Initiator is HFPO dimer peroxide (CF₃CF₂CF₂—O—CF(CF₃)C(O)O—OCOCF(CF₃)—O—CF₂CF₂CF₃), Initiator is 20 wt % in diluent (Vertrel® XF, which is 2,3-dihydrodecafluoropentane). Initiator feed rate is 3 g of HFPO dimer peroxide per hour. Under these conditions, polymer production rate is 436 g/hr. Polymer composition is 10.1 wt % HFP (calculated from HFPI×3.2) and 1.48 wt % PEVE (analysis method disclosed in U.S. Pat. No. 5,677,404), the remainder to total 100 wt % being TFE. Melt flow rate (MFR) is 33.8 g/10 min at 372° C. with a 5 kg weight. The polymer melting point is 260° C. Acid fluoride endgroups on the polymer are 36 per million carbon atoms. No —CONH₂ and —COOH groups are detected. Analysis for olefin (—CF═CF₂) end groups is also made and none are detected. The monomers, CO₂, and HFPO dimer peroxide and a small amount of its diluent (about 1 part per thousand of monomer and CO₂ feed) are the only ingredients present in the polymerization system, whereby there is no halocarbon solvent polymerization medium, no dispersing agent, and no inorganic salt (ionic species).

After decompression of the reactor, the perfluoropolymer is obtained in the form of free-flowing powder, which can be used directly in melt processing.

A container made from this polymer is made by blow molding of a tubular parison at an extrusion temperature of 370-380° C. (700-715° F.). A description of blowmolding can be found in Fluoroplastics. Vol. 2: Melt Processible Fluoropolymers by Sina Ebnesajjad, Plastics Design Library, Norwich N.Y., [2003], Chapter 10, p. 299ff.

A tank lining is made from this polymer by melt extruding a 3 mil (0.76 mm) thick film, followed by adhering this film to the interior surface of a steel vessel. The resulting coating is pure FEP. Tubing having an outer diameter of 50 mm and wall thickness of 6 mm is made using this polymer by melt extrusion at a melt temperature of 390° C. (734° F.).

A basket for holding silicon wafers for transport through liquid processing in the wafer manufacture of semiconductors is made by injection molding of this polymer at a temperature of 370° C. (700° F.).

The foregoing articles are also made of the PFA made substantially in accordance with Example 1 of U.S. Pat. No. 6,051,682, at melt extrusion temperatures of 380-395° C. (715-745° F.).

### Example 2

The FEP used in Example 1 is also used for coating wire by melt draw-down extrusion at a melt temperature using a 60 mm bore diameter extruder in which the screw rotation is 24 RPM and which has the following temperature profile in ° C.:

| Zone 1 | 2 | 3 | 4 | 5 | Clamp | Adapter | Head | Die | Tip |
|---|---|---|---|---|---|---|---|---|---|
| 343 | 348 | 360 | 371 | 373 | 377 | 382 | 388 | 393 | 393 |

The extrusion coating is carried out at a line speed of 1200 ft/min (366 m/min), which is excellent line speed for the category 6 wire being made, i.e. wherein the copper wire is 0.0226 in (0.574 mm) in diameter and the FEP insulation thickness is 7 to 8 mils (0.18 to 0.20 mm). This extrusion is carried out for about 11 hrs to produce about 800,000 ft (244,000 m) of category 6 wire without the formation of any lumps in the wire insulation. This extrusion run is stopped after this production of 244,000 m of insulated wire because the demonstration of success is considered completed. A lump is a sudden increase in insulation thickness to at least 2× the original diameter of the insulated wire, and is formed by buildup of molten resin at the exterior of the extrusion orifice, this buildup being periodically carried away by the extruded melt cone. Lumps interfere with the subsequent twinning of the insulated wire to form category 6 cable and can even cause the insulated wire to snap (break) during the twinning process. To satisfy category 6 requirements, broken insulated wire cannot be welded together, whereby the wire break forms the end of the cable being wound up. Excellent extrusion results are also obtained when the line speed is increased to 1500 ft/min (457 m/min). That the cable is category 6 is satisfied by testing against the performance requirements.

This extrusion performance was as good as that for fluorinated FEP of similar MFR made by aqueous dispersion polymerization using inorganic salt initiator and dispersing agent. The FEP of Example 1 used in this extrusion comparison was not fluorinated after polymerization.

### Example 3

In the Example, the dissipation factor, D_{f}, is determined in two ways.
(A) D_{f} is calculated from the total cable loss of coaxial cable insulated with the polymer. Total cable loss is measured on 1-meter lengths of coaxial cable having these characteristics: Core conductor diameter: 0.521 mm; FEP Insulation on core wire outer diameter: 1.67 mm; Metal shield on insulation outer diameter: 2.38 mm. D_{f} is a component of Total Cable Loss, L, and can be calculated from the equation:

$$L = \frac{0.016 \times ( 2.26 + {ɛ}_{r}^{′} ) \times \sqrt{f}}{{D}_{s}} + 0.09 \times {D}_{f} \times \sqrt{{ɛ}_{r}^{′}} \times f$$

ƒ Frequency in Hz

Ds Internal diameter of the shield

ε′_{f} Dielectric constant of the dielectric

D_{f} Dissipation factor of the dielectric

L Total cable loss in dB/m
(B) Alternatively, D_{f} may be directly measured on plaques about 2.5 mm (0.1 inch) thick using the standing wave method in a circular hollow wave guide similar to the procedure described in ASTM D-2520.

Calculation of D_{f} from total cable loss gives higher numerical values than when the measurement is made on compression-molded plaques of the perfluoropolymer. D_{f} derived from cable loss measurement, divided by 1.5, approximates D_{f} measured on plaques.

D_{f} calculated from total cable loss for polymers of the Examples is reported in columns 2 and 3 of Table 1. D_{f} measured directly on plaques is reported in column 4 of the Table.

TABLE 1

| | Dissipation Factor (D_{f}) at 10 GHz | | |
|---|---|---|---|
| | Determined from | | |
| | Total Cable Loss (L) | | Determined from |
| | Solid | Foamed | Plaques |
| Polymer | Insulation | Insulation | Solid Plaques |
| Aqueous | 0.00105 | 0.00068 | 0.00065* |
| dispersion FEP | | | |
| Fluorinated aq. | 0.00045 | 0.00032 | 0.00027 |
| dispersion FEP | | | |
| FEP of Example 1 | 0.00048 | — | 0.00035 |
| Fluorinated FEP | 0.00034 | 0.00015 | 0.00022 |
| of Example 1 | | | |

*Estimated from ratio of dissipation factor of non-fluorinated aqueous dispersion polymerized FEP (0.00084) to fluorinated FEP (0.00035) also made by aqueous dispersion polymerization (disclosed in Table 1 of European Patent 0 423 995) × 0.00027.

The dissipation factor for the solid plaques is determined on compression molded plaques of about 2.5 mm in thickness using Method B of ASTM 2520, wherein the electric field inside the resonant cavity is parallel to the length (15.24 cm) of the plaque.

The aqueous dispersion FEP is made by aqueous dispersion polymerization using an inorganic salt initiator and the end groups are stabilized by humid heat treatment to give the stable —CF₂H end group as described in U.S. Pat. No. 3,085,083. This applies to the aqueous dispersion FEP described in Table 1 above and to the FEP on which dissipation factor is measured in EP 0 423 995. Water has been the polymerization medium for commercially produced FEP since its discovery (U.S. Pat. No. 2,946,763). The composition of the aqueous dispersion FEP in Table 1 above is almost identical with that of the FEP made in Example 1 herein. The extrusion fluorination used for the aqueous dispersion FEP is that described in U.S. Patent Application No. 2004/0092669, Example 2. The fluorination of the Example 1 FEP is that which is described in U.S. Pat. No. 4,743,658 and EP 0 423 995. No unstable end groups are detectable in either the fluorinated FEP made by aqueous dispersion polymerization or the fluorinated FEP of Example 1, i.e. the different fluorination techniques produce the same end group stabilization result, which is less than 20 hydrogen-containing end groups, —COF and —CF═CF₂ end groups per 10⁶ carbon atoms.

The results in the foregoing table show that surprisingly the dissipation factor for unfluorinated FEP of Example 1 (0.00048) is much less than that of the unfluorinated FEP made by aqueous dispersion polymerization (0.00105) and very close to that of the fluorinated FEP made by aqueous dispersion polymerization (0.00045). The fluorination treatment of the FEP of Example 1 reduces the dissipation factor even further (0.00034), making it superior to the fluorinated aqueous dispersion FEP.

The foamed FEP insulation contains about 50 volume % voids. The results in the table show that foaming also reduces dissipation factor, but that the unfoamed fluorinated FEP of Example 1 (0.00034) is about as good as the foamed FEP made by fluorination of aqueous dispersion polymerization FEP (0.00032). The foamed FEP of Example 1 produces an extraordinarily low dissipation factor (0.00015).

These results are exhibited by dissipation factor measurement on the coaxial cable. For such cable, the dissipation factor is preferably no greater than about 0.00040 at 10 GHz, which is obtainable by fluorination. When the insulation is foamed, the coaxial cable preferably exhibits a dissipation factor at 10 GHz of no greater than about 0.00040 without fluorination of the perfluoropolymer and no greater than about 0.00025 after fluorination of the perfluoropolymer, more preferably no greater than about 0.00020.

Similar improvement is exhibited for dissipation factor measurement made on the perfluoropolymer per se, i.e. compression molded plaques instead of measurement made on cable. The dissipation factor for fluorinated FEP made by aqueous dispersion polymerization disclosed in Table 1 of EP 0 423 995 is 0.00035. The fluorinated FEP made by aqueous dispersion polymerization in Table 1 above is 0.00027. The fluorinated FEP of Example 1 herein is lower than both these results, namely 0.00022. The improvement is even more pronounced for unfluorinated FEP, 0.00070 for the aqueous dispersion FEP as compared to only 0.00035 for the FEP of Example 1 herein as shown in Table 1 above. Preferably, the dissipation factor of the perfluoropolymer per se (measured on plaques) and made by the polymerization in accordance with the present invention is no greater than about 0.00040 and after fluorination, is no greater than about 0.00025, all determined at 10 GHz.

What is claimed is:

1. Article for non-contaminating contact with non-food liquid and food in which at least the surface of said article in contact with said non-food liquid or food is melt-fabricable perfluoropolymer that as-polymerized is free of ionic species, dispersing agent, and halocarbon solvent polymerization medium.

2. The article of claim 1 wherein the said melt-fabricable perfluoropolymer is formed by polymerization in a medium comprising carbon dioxide.

3. The article of claim 1 as a containment article, such as tubing, piping, liner (tank or pipe), rigid container, or container made of flexible film, or as a processing fixture.

4. Process comprising extrusion coating wire with melt-fabricable perfluoropolymer, said perfluoropolymer as-polymerized being free of dispersing agent, ionic species, and halocarbon solvent polymerization medium, whereby said coating is free of lumps when said coating is carried out at a speed of at least 1000 ft/min (305 m/min) for at least 8 hours.

5. The process of claim 4 wherein said extrusion is melt-draw down extrusion.

6. Insulated wire, wherein the insulation is melt-fabricable perfluoropolymer that as-polymerized is free of ionic species, dispersing agent, and halocarbon solvent polymerization medium, said insulated wire having an improved dissipation factor at 10 GHz as compared to the same perfluoropolymer made by aqueous dispersion polymerization.

7. The insulated wire of claim 6 wherein said perfluoropolymer exhibits a dissipation factor of no greater than about 0.00040.

8. The insulated wire of claim 6 wherein said perfluoropolymer is fluorine treated and exhibits a dissipation factor of no greater than about 0.00025.

9. The insulated wire of claim 6 as coaxial cable or twisted pair cable.

10. The insulated wire of claim 9 wherein as coaxial cable and exhibiting a dissipation factor as measured on said coaxial cable of no greater than 0.00050 at 10 GHz.

11. The insulated wire of claim 6 wherein said perfluoropolymer is fluorine treated.

12. The insulated wire of claim 11 as coaxial cable exhibiting a dissipation factor is no greater than 0.00040 at 10 GHz.

13. The insulated wire of claim 11 as coaxial cable and wherein said insulation is foamed, the resultant cable exhibiting a dissipation factor is no greater than 0.00025 at 10 GHz.

14. The insulated wire of claim 6 wherein said perfluoropolymer is tetrafluoroethylene/hexafluoropropylene copolymer
